(19) United States
(12) Patent Application Publication
(10) Pub. No.: US 2024/0338830 A1
(43) Pub. Date: Oct. 10, 2024

(54) SYSTEMS AND METHODS FOR MULTIPLE-OBJECT TRACKING

(71) Applicant: Palantir Technologies Inc., Denver, CO (US)

(72) Inventors: Aleksandr Patsekin, Foster City, CA (US); Ben Radford, Denver, CO (US); Daniel Marasco, Washington, DC (US); Dimitrios Lymperopoulos, Kirkland, WA (US); Keun Jae Kim, Kirkland, WA (US); Michel Goraczko, Seattle, WA (US); Prasanna Srikhanta, Seattle, WA (US); Rodney LaLonde, Arlington, VA (US); Tong Shen, Redmond, WA (US); Xin Li, Cupertino, CA (US); Yue Wu, Lynnwood, WA (US); Cameron Derwin, Seattle, WA (US); Di Wang, Sammamish, WA (US)

(21) Appl. No.: 18/625,961

(22) Filed: Apr. 3, 2024

Related U.S. Application Data
(60) Provisional application No. 63/458,335, filed on Apr. 10, 2023.

(51) Int. Cl. G06T 7/20

(52) U.S. Cl. CPC G06T 7/20

(57) ABSTRACT

In some examples, systems and methods for user-assisted object detection are provided. For example, a method includes: receiving a first image frame in a sequence of image frames, performing object tracking using an object tracker to identify a first object of interest and a second object of interest in the first image frame based at least in part on one or more first templates associated with the first object of interest, one or more second templates associated with the second object of interest, and a spatial relationship between the first object of interest and the second object of interest, outputting a first indicator associated with a first image portion corresponding to the identified first object of interest, and outputting a second indicator associated with a second image portion corresponding to the identified second object of interest.

### CROSS REFERENCE TO RELATED APPLICATIONS

This application claims priority to U.S. Provisional Application No. 63/458,335, entitled “SYSTEMS AND METHODS FOR MULTIPLE-OBJECT TRACKING,” and filed on Apr. 10, 2023, which is incorporated by reference herein for all purposes in its entirety.

### TECHNICAL FIELD

Certain embodiments of the present disclosure relate to object tracking. More particularly, some embodiments of the present disclosure relate to multiple object tracking (MOT).

### BACKGROUND

There are two major computer vision based object tracking models: MOT and single object tracking (SOT). Often, MOT models require training a detector with predefined classes and the tracking detected objects of predefined classes across frames of a video. Comparatively, often SOT models do not require a separately trained object detector, but instead can be designed to track any generic object by specifying the target of interest. Hence, it is desirable to improve techniques for object tracking.

### SUMMARY

Certain embodiments of the present disclosure relate to object tracking. More particularly, some embodiments of the present disclosure relate to multiple object tracking (MOT).

At least some aspects of the present disclosure are directed to a method for user-assisted multi-object tracking. The method includes: receiving a first image frame in a sequence of image frames: performing object tracking using an object tracker to identify a first object of interest and a second object of interest in the first image frame based at least in part on one or more first templates associated with the first object of interest, one or more second templates associated with the second object of interest, and a spatial relationship between the first object of interest and the second object of interest; and outputting a first indicator associated with a first image portion corresponding to the identified first object of interest: outputting a second indicator associated with a second image portion corresponding to the identified second object of interest. The method is performed using one or more processors.

At least some aspects of the present disclosure are directed to a system for user-assisted multi-object tracking. The system includes at least one processor and at least one memory storing instructions that, when executed by the at least one processor, causes the system to perform a set of operations, the set of operations comprising: receiving a first image frame in a sequence of image frames: performing object tracking using an object tracker to identify a first object of interest and a second object of interest in the first image frame based at least in part on one or more first templates associated with the first object of interest, one or more second templates associated with the second object of interest, and a spatial relationship between the first object of interest and the second object of interest; and outputting a first indicator associated with a first image portion corresponding to the identified first object of interest: outputting a second indicator associated with a second image portion corresponding to the identified second object of interest.

At least some aspects of the present disclosure are directed to a method for multiple-object tracking. The method includes: receiving a first image frame in a sequence of image frames: performing object tracking using an object tracker to identify a plurality of objects of interest based at least in part on one or more first templates associated with a first object of interest from the plurality of objects of interest, one or more second templates associated with a second object of interest from the plurality of objects of interest, and a spatial relationship between at least two objects of interest of the plurality of objects of interest, wherein the spatial relationship comprises a distance between at least two objects of interest of the plurality of objects of interest; and outputting a plurality of indicators. Each indicator of the plurality of indicators is associated with a respective image portion. Each image portion of the respective image portions corresponds to a respective object of interest of the plurality of objects of interest. The method further includes: determining whether at least one of the objects of interest satisfies one or more criteria; and generating a template based on the at least one of the objects of interest. The method is performed using one or more processors.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is an illustrative example of an object detection system or workflow, according to certain embodiments of the present disclosure

FIG. 2A is an illustrative example of a method for object tracking, according to certain embodiments of the present disclosure.

FIG. 2B is an illustrative example of a method for object tracking, according to certain embodiments of the present disclosure.

FIG. 3 is a simplified diagram showing a method for object tracking according to certain embodiments of the present disclosure.

FIG. 4 is an illustrative example of a user interface with indicators associated with identified objects of interest according to certain embodiments of the present disclosure.

FIG. 5 is an illustrative example of a user interface with retarget user input according to certain embodiments of the present disclosure.

FIG. 6 illustrates a simplified diagram showing a computing system for object tracking, according to certain embodiments of the present disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any number within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods often have false predictions, missing predictions in tracking multiple objects in visual data (e.g., a video stream, a sequence of images). Conventional systems and methods typically use object-detecting algorithms and suffer significant degraded performance when deployed to visual data capturing a new geographic location.

Various embodiments of the present disclosure can achieve benefits and/or improvements by a computing system using an object tracker to track multiple objects that uses spatial contexts, and/or prompts user inputs. In some embodiments, benefits include significant improvements, including, for example, increased efficiency, reduced complexity, and improved accuracy, in tracking multiple objects in a video stream, a sequence of images, and/or the like. In certain embodiments, systems and methods are configured to track multiple objects using an object tracker that uses templates associated with multiple objects and the spatial relationship of the multiple objects.

At least some embodiments of the present disclosure are directed to multiple-object tracking. In certain embodiments, an object tracking system (e.g., an object tracking software, an object tracking platform, etc.) can tracking multiple objects over a period of time (e.g., 5 minutes, 10 minutes, 1 hour, 1 day, 10 days, etc.). In some embodiments, the object tracking system can determine one or more spatial relationships between one or more targets of interest (e.g., objects of interest) and identify the one or more targets of interest based at least part on the one or more spatial relationship in one or more subsequent image frames in a sequence of image frames (e.g., a video). In certain embodiments, a target of interest is associated with a tracking identifier (ID).

According to certain embodiments, the object tracking system can use one or more user inputs to adjust and/or correct the object tracking (e.g., retargeting to the object of interest). In some embodiments, the object tracking system uses the one or more user inputs to generate and/or update a template for an object of interest. In certain embodiments, a template refers to an image (e.g., an image section of an image) and/or one or more features extracted from the image. For example, the features extracted from the image may include pixel values, shapes, vectors, and/or other elements of an image which can be extracted based on objects of interest to be detected. In some embodiments, a template is associated with an object of interest. In certain embodiments, the image of the template is a portion of a captured image (e.g., a frame, a still image, a sequence of images, a video). In some embodiments, a frame, also referred to as an image frame, is an image in a sequence of images or an image in a video. In some examples, the frame may be received from an image sensor (e.g., a still camera, a video camera, and/or a satellite).

According to certain embodiments, the systems and methods of object tracking use a computing model (e.g., a machine-learning model). In certain embodiments, a model, also referred to as a computing model, includes a model to process data. A model includes, for example, an artificial intelligence (AI) model, a machine-learning (ML) model, a deep-learning (DL) model, an artificial neural network (ANN), a deep neural network (DNN), an image processing model, an algorithm, a rule, other computing models, and/or a combination thereof.

According to some embodiments, there are two major types of visual object tracking models (e.g., visual object tracking paradigms): (i) multiple object tracking (MOT) and (ii) single object tracking (SOT). In certain embodiments, the MOT model requires first training a detector with predefined classes and then tracking/associating detected objects of predefined classes across frames of a video. In certain embodiments, a detector, also referred to as a software detector or an object detector, refers to an ML detector, a DL detector, an ANN detector, a DNN detector, and/or the like. In some embodiments, the software detector includes a SOT model. In certain embodiments, the MOT model consists of a jointly trained detector with predefined classes and trackers to detect and track objects across frames of a video. In some embodiments, the SOT model does not require a separately trained object detector. In certain embodiments, the SOT model is designed to track an object (e.g., any generic object) by drawing a bounding box around the target of interest (e.g., an object of interest).

According to certain embodiments, an object tracking system (e.g., an object tracking platform, an object tracking software) includes a software module using computer vision task with a user interface that allows a user to provide a user input related to the target of interest (e.g., object of interest), and then detect and track the target. In some embodiments, the user input includes drawing a bounding box around the target of interest. In certain embodiments, the user input includes a click on an image, for example, at the target of interest. In some embodiments, the object tracking system can track a target based on visual appearance, for example, the visual appearance that the user specified. In certain embodiments, for long-term tracking (e.g., 5 minutes, 10 minutes, 1 hour, 1 day, 10 days, etc.), object appearance, camera view angle, zooming level, lighting and background can change significantly over time. In some embodiments, these factors pose some challenges in learning and discriminating the target object from distractors (e.g., other similar looking objects) and background over time.

According to certain embodiments, the user input is generated by a machine-learning model (e.g., a language model). In some examples, the machine-learning model is a language model (“LM”) that may include an algorithm, rule, model, and/or other programmatic instructions that can predict the probability of a sequence of words. In some embodiments, a language model may, given a starting text string (e.g., one or more words), predict the next word in the sequence. In certain embodiments, a language model may calculate the probability of different word combinations based on the patterns learned during training (based on a set of text data from books, articles, websites, audio files, etc.). In some embodiments, a language model may generate many combinations of one or more next words (and/or sentences) that are coherent and contextually relevant. In certain embodiments, a language model can be an advanced artificial intelligence algorithm that has been trained to understand, generate, and manipulate language. In some embodiments, a language model can be useful for natural language processing, including receiving natural language prompts and providing natural language responses based on the text on which the model is trained. In certain embodiments, a language model may include an n-gram, exponential, positional, neural network, and/or other type of model.

In examples, the machine-learning model is a large language model (LLM), which was trained on a larger data set and has a larger number of parameters (e.g., billions of parameters) compared to a regular language model. In certain embodiments, an LLM can understand more complex textual inputs and generate more coherent responses due to its extensive training. In certain embodiments, an LLM can use a transformer architecture that is a deep-learning architecture using an attention mechanism (e.g., which inputs deserve more attention than others in certain cases). In some embodiments, a language model includes an autoregressive language model, such as a Generative Pre-trained Transformer 3 (GPT-3) model, a GPT 3.5-turbo model, a Claude model, a command-xlang model, a bidirectional encoder representations from transformers (BERT) model, a pathways language model (PaLM) 2, and/or the like. Thus, a prompt describing an object to be tracked may be provided for processing by the LLM, which thus generates a recommendation accordingly.

According to some embodiments, the object tracking system may use computer vision based multiple object tracking (MOT) to detect and track a plurality of objects of interest by first detecting objects, then assigning an identifier (ID) (e.g., a tracking ID) to each object of interest and maintaining their IDs throughout a video (e.g., a sequence of image frames). In certain embodiments, computer vision based multiple-object tracking may use tracking by detection approaches. In some embodiments, the object tracking may require large amount of labeled data to first train an object detector with predefined classes and then to track/associate detected objects of predefined classes across image frames of a video (e.g., a sequence of image fames).

According to certain embodiments, an object tracking system may suffer from the following issues: 1) MOT approaches can easily have false predictions, missing predictions, and ID switches, for example, especially for videos with tiny objects and large camera movement, zooming in/out etc.: 2) in a conventional system, when a MOT tracker fails (e.g., lost the target, tracking the wrong target), a user typically cannot do anything to correct the MOT tracker failures: 3) in a conventional system, when a MOT is deployed in a new geo-location where object and background appearances are different from the training dataset, detection and tracking performance will be significantly degraded. In some examples, new data need to be collected and labeled, and conventional detectors and trackers need to be retrained/fine-tuned which are very costly and time consuming: 4) when new classes (e.g., new object classes) have been introduced, new data needs to be collected and labeled to retrain the conventional detector and fine-tune the conventional tracker; and/or 5) even when tracking has good performance for some video feeds, detecting and tracking all objects, using conventional systems, can distract a user when the user wants to focus on only a few targets on the screen. In some embodiments, an ID switch can refer to an incorrect object being identified and/or an identified object being assigned to an incorrect tracking ID.

According to some embodiments, to address one or more above issues, the object tracking system provided herein includes an interactive MOT, a new workflow and a mechanism to enable the one or more of the following features: 1) tracking any number of objects by allowing a user to draw a bounding box on each target without predefining object class (e.g., object class ontology): 2) because a user specifies the exact objects to track and the tracker can learn the object appearance changes on the fly, tracking can have better performance in different deployment environments and datasets, and for example, can track the targets longer and more robustly: 3) when MOT fails, a user can interact with the MOT tracker to correct the mistakes by a single click on the right target to track; and/or 4) the object tracking system allows a user to focus on what he/she wants to focus on, rather than being distracted by irrelevant objects on the user interface (e.g., on the screen).

According to certain embodiments, the object tracking system may allow one or more types of interactions. In some embodiments, the object tracking system allows a user to draw a box for each target of interest to track. In certain embodiments, the object tracking system allows a user to draw multiple boxes for multiple targets of interest. In some embodiments, the object tracking system allows a user to click an existing bounding box for a target of interest to track. In certain embodiments, the object tracking system allows a user to click multiple existing bounding boxes. In some embodiments, the object tracking system allows a combination of one or more existing bounding boxes and one or more new drawn boxes. In certain embodiments, the object tracking system can allow users to use UI options to click on a target of interest and/or reassign the right ID to correct MOT tracker mistakes, for example, when the target is lost and/or ID switches (e.g., a wrong target being identified).

In some embodiments, by enabling the user to reassign the right ID to correct MOT tracker mistakes, the object tracking system provides better performance in object tracking. In certain embodiments, the user is enabled to guide the object tracking system to remain on the target even if the image data did not allow the object tracking system to identify the correct target in a subsequent frame. In certain embodiments, by enabling the user correction, the object tracking system is enabled to identify correctly, and thereby track, the target in further subsequent frames. In some embodiments, these improvements over conventional object tracking systems are expected to be particularly useful in situations where a current environment is sufficiently different to environments from which training data was obtained because of the otherwise reduced tracking performance that would be provided from imperfect training data. In some embodiments, improved tracking performance can be in terms of improved duration of tracking and/or improved robustness/reliability of tracking.

According to some embodiments, an object tracking system may use multiple SOTs with each SOT tracking a target of interest specified by the user. In certain embodiments, the multiple SOTs approach may have one or more disadvantages of being inefficient; requiring multiple GPUs: not leveraging the fact that a user is tracking multiple objects at the same time, tracking each object independently may still suffer from identifier switches among multiple objects, false positives, and/or false negatives.

According to certain embodiments, the object tracking system may use a MOT (e.g., a MOT module) to coordinate the multiple SOTs so that the system may exploit the spatial relationship between these targets of interest. For example, a user can provide input of search area (e.g., where to search for the target of interest) to each SOT. As an example, a user may provide positive samples and/or negative samples to update the template and/or the SOT during the running of the object tracking system.

In some embodiments, using an MOT coordinated with one or more SOTs provides improved tracking performance. Specifically, in certain embodiments, SOTs can provide better performance on tracking a single object than a conventional MOT. Accordingly, in some embodiments, by configuring the MOT to coordinate one or more SOTs and tracking multiple objects using data indicating the spatial relationship between the objects—data that SOTs and conventional MOTs do not take into account—the tracking performance of the multiple objects is improved. In some embodiments, improved tracking performance can be in terms of improved duration of tracking and/or improved robustness/reliability of tracking. In some embodiments, the MOT may be provided with integrated SOTs, rather than coordinating external SOTs, and the MOT coordinating SOTs thus can be performed wholly within an MOT module.

According to some embodiments, the object tracking system includes one or more template repositories (e.g., template galleries) to store user provided templates as well as the tracker (e.g., the SOT tracker, the SOT model, the object tracker) inferred templates (e.g., templates based on model outputs) to capture appearance changes. In certain embodiments, the object tracking system includes a spatial context repository (e.g., a spatial context gallery) to capture the changes of one or more spatial relationships between two or more targets of interests to be tracked over time.

According to certain embodiments, the object tracking system includes one or both of the features of: 1) feature extraction for one or more templates (e.g., templates generated based on user inputs, templates generated based on model outputs) and one or more image frames (e.g., each frame of image frames): 2) similarity matching. In some embodiments, the object tracking system can either use two streams two stages (e.g., template and image frame use two feature extractors, and feature extractor and similarity matching or relationship modeling use different deep neural networks) architectures or one stream one stage (e.g., both feature extractors for template and image frame, and similarity matching or relationship modeling use the same deep neural network) architectures. In certain embodiments, rather than independently matching each template with the image frame (e.g., the entire image frame) and/or feature map (e.g., the feature map for the entire image frame) which is not only inefficient, but also tend to ID switches to other targets/distractors, the object tracking system can jointly match one or more templates associated with one or more tracking IDs (e.g., user specified templates) with the image features. In some embodiments, by maintaining the spatial relationship, the object tracking system can potentially significantly reduce ID switches and also track more robustly as the spatial context and continuity across time is strong, for example, for where to pay attention.

In certain embodiments, by maintaining the spatial relationship, the object tracking system can potentially significantly reduce ID switches and also track more robustly as the spatial context and continuity across time meets one or more criteria. In some examples, the criteria include a criterion of spatial relationship change. In certain examples, the one or more criteria include a criterion of appearance change. For example, when the tracker is confident about one target location, but less confident about the other two targets, the tracker (e.g., the MOT tracker) can leverage their previous spatial relationship and estimated motion to predict where most likely the two targets should be. In some embodiments, the spatial relationship can be represented by a graph. In certain embodiments, the spatial relationship can be represented by a spatial graph.

According to some embodiments, some tracker approaches periodically update a tracker (e.g., a neural network, a part of the neural network weights) in an online fashion (e.g., updating the correlation filter weights of the neural network). In certain embodiments, the object tracking system uses a predictor (e.g., a predictor model, a machine-learning predictor model, a deep-learning predictor model) to predict target appearance. In some embodiments, the object tracking system can learn the target appearance changes over time.

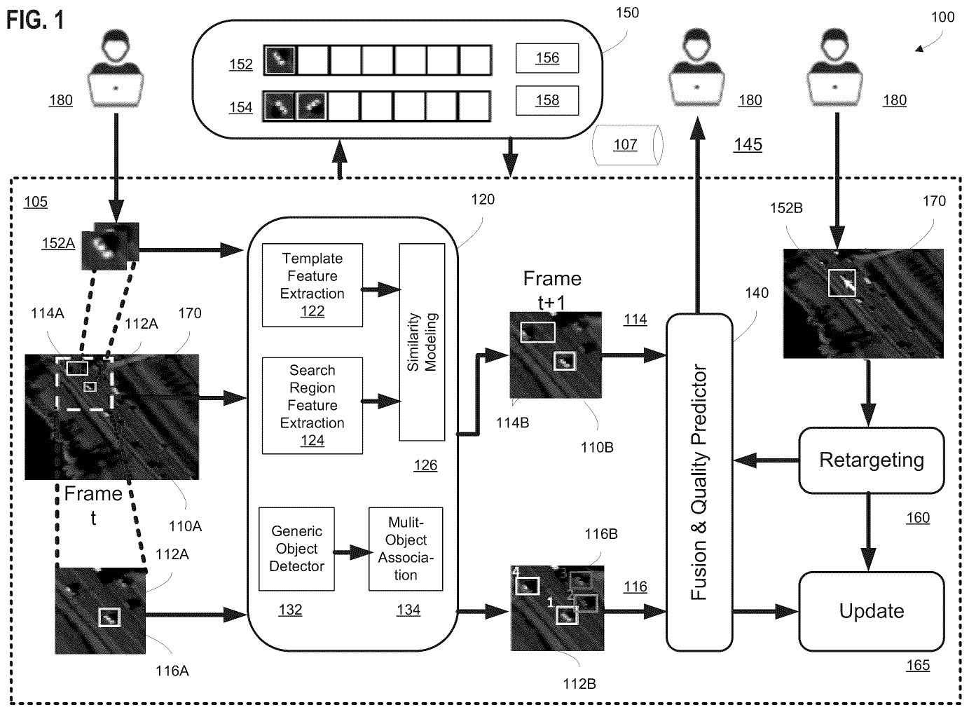

FIG. 1 is an illustrative example of an object tracking system or workflow 100, according to certain embodiments of the present disclosure. FIG. 1 is merely an example. One of ordinary skill in the art would recognize many variations, alternatives, and modifications. According to some embodiments, the object tracking system includes an object tracker 120 (e.g., an object tracking module, an object tracking software module), a fusion and quality predictor 140, a data repository 150, a retargeting module 160, an update module 165, and a user interface 170 that allows users 180 to interact with the system 100. In certain embodiments, the object tracker 120, the fusion and quality predictor 140, the retargeting module 160, and/or the update module 165 are integrated into a piece of software 105. In some embodiments, the object tracking system 100 includes a storage repository 107, for example, including the data repository 150. In certain embodiments, the update module 165 interacts with the data repository 150.

According to certain embodiments, the data repository 150 includes one or more template galleries and one or more spatial context galleries. In some embodiments, the data repository 150 includes a short-term template repository 152 (e.g., a short-term template gallery) and a long-term template repository 154 (e.g., a long-term template gallery). In certain embodiments, the data repository 150 includes a short-term spatial context repository 156 (e.g., a short-term spatial context gallery) and a long-term spatial context repository 158 (e.g., a long-term spatial context gallery). In some embodiments, the object tracking system 100 differentiates user identified templates (e.g., user provided templates) and algorithm and/or model derived and/or estimated templates. In certain embodiments, the object tracking system 100 includes two or more types of templates. In some embodiments, a type of templates includes templates generated based on user inputs, also referred to as long-term templates. In certain embodiments, a type of templates includes algorithm and/or model derived and/or estimated templates, or templates generated based on model outputs, also referred to as short-term templates. In some embodiments, the short-term templates include templates that are not generated based on user inputs. In certain embodiments, the short-term templates include templates that are not generated directly based on user inputs.

In some embodiments, the users 180 can be prompted to provide feedback to the object tracking system 100, for example, such as providing input to correct tracking (e.g., a statement of “a vehicle on the left”), to generate the templates, and/or the like. In some embodiments, the users 180 can be prompted to provide feedback at regular intervals. In some embodiments, the users 180 can be prompted to provide feedback at irregular intervals. In some embodiments, the users 180 can provide feedback without being prompted (e.g., between adjacent prompting instances, before a prompting instance has occurred, and/or after a prompting instance has occurred).

In some embodiments, the user input is generated by a machine-learning model (e.g., a language model). In some examples, the machine learning model is an LM that may include an algorithm, rule, model, and/or other programmatic instructions that can predict the probability of a sequence of words. In some embodiments, an LM may, given a starting text string (e.g., one or more words), predict the next word in the sequence. In certain embodiments, an LM may calculate the probability of different word combinations based on the patterns learned during training (based on a set of text data from books, articles, websites, audio files, etc.). In some embodiments, an LM may generate many combinations of one or more next words (and/or sentences) that are coherent and contextually relevant. In certain embodiments, an LM can be an advanced artificial intelligence algorithm that has been trained to understand, generate, and manipulate language. In some embodiments, an LM can be useful for natural language processing, including receiving natural language prompts and providing natural language responses based on the text on which the model is trained. In certain embodiments, an LM may include an n-gram, exponential, positional, neural network, and/or other type of model.

In examples, the machine learning model is an LLM, which was trained on a larger data set and has a larger number of parameters (e.g., billions of parameters) compared to a regular LM. In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pre-trained Transformer 3 (GPT-3) model, a GPT 3.5-turbo model, a Claude model, a command-xlang model, a bidirectional encoder representations from transformers (BERT) model, a pathways language model (PaLM) 2, and/or the like. Thus, in some examples, a prompt describing an object to be tracked may be provided for processing by the LLM, which thus generates a recommendation accordingly.

In some embodiments, the object tracking system 100 includes two or more template repositories (e.g., template galleries), for example, a long-term template repository 152 and a short-term template repository 154. In some embodiments, the long-term template repository 152 (e.g., long-term gallery) is configured to store user provided initial templates and retargeting templates. In certain embodiments, the short-term template repository 154 (e.g., short-term gallery) is configured to store estimated and/or inferred templates with high confidence generated from the object tracker 120.

According to certain embodiments, the object tracking system 100 includes an initialization process. In some embodiments, the object tracking system 100 receives a first user input, for example, a first bounding box indicating and/or around a first object of interest (e.g., the target, the object of Track 1). In certain embodiments, the object tracking system 100 receives a second user input, for example, a second bounding box indicating and/or around a second object of interest (e.g., the target, the object of Track 2). In some embodiments, the first bounding box and/or the second bounding box can be a drawn bounding box and/or a clicked bounding box. In certain embodiments, the bounding box is a closed shape. In some examples, the bounding box may be a square, or a circle, or a triangle, or any other regular polygon which should be recognized by those of ordinary skill in the art. In some examples, the bounding box may be an irregular polygon, as should be recognized by those of ordinary skill in the art.

In certain embodiments, the object tracking system 100 determines a spatial relationship between the first object of interest and the second object of interest. In certain embodiments, after receiving the user inputs, the object objecting system 100 initializes and/or configures the object tracker 120 with the assigned tracking IDs.

In some embodiments, a spatial relationship includes a spatial encoding of locations of two or more objects. In certain embodiments, the spatial relationship includes a spatial graph. In some embodiments, a spatial graph includes one or more nodes of spatial locations, usually given by coordinates in one, two or three dimensions. In certain embodiments, the spatial relationship includes relative positions of two or more objects.

In some embodiments, the system 100 generates one or more initial templates 152A (e.g., an image portion illustrating a vehicle, extracted features from an image portion illustrating a vehicle, etc.) based on the user input and adds the initial template to the data repository 150 and/or the long-term template repository 152. In certain embodiments, the object tracking system 100 generates two initial templates, one initial template for the first object of interest and one initial template for the second object of interest. In some embodiments, the object tracking system 100 includes a respective long-term template repository 152 for an object of interest. In certain embodiments, the object tracking system 100 includes a respective short-term template repository 152 for an object of interest. In some embodiments, the object tracking system 100 stores the determined spatial relationship into a spatial context repository, for example, a long-term spatial context repository 156. In certain examples, the data repository 150 includes two or more long-term template repositories. In some embodiments, the object tracking system 100 initializes the object tracker 120 using the initial templates 152A. In certain embodiments, each of the identified objects by the object tracker 120 has a tracking ID. In some embodiments, each identified object by the object tracker 120 across different frames is assigned with the same tracking ID. For example, the tracking ID for the object of interest remains the same (e.g., the initial tracking ID, Track 1) across multiple image frames.

In certain embodiments, the object tracker 120 processes an image frame (e.g., the image frame 110A, the image frame 110B) to generate the tracking output 114 associated with the objects of interest (e.g., the targets, the targets of interest), for example, one or more detected region associated with the objects of interest, one or more bounding boxes associated with the objects of interest, and/or the like. In some embodiments, the image frames 110A, 110B are received from one or more image sensors (e.g., one or more still cameras, video cameras, and/or satellites).

In some embodiments, the object tracker 120 identifies one or more objects of interest by matching. In certain embodiments, the object tracker 120 identifies the one or more objects of interest by matching the one or more objects of interest with a respective template. In some embodiments, the object tracker 120 identifies the one or more objects of interest by matching the one or more objects of interest with respective templates and/or matching one or more spatial relationships between the one or more objects of interest with respective spatial relationships (e.g., spatial relationships stored in the spatial context repository 156 and/or 158).

In some embodiments, a match is found when two images (e.g., two image areas, two image sections, two set of features extracted from two images), such as a bounding box representing an identified object by the object tracker 120 and one or more object templates, are within a certain IOU (intersection of union) threshold. In certain embodiments, the IOU threshold is a predetermined IOU threshold. In certain embodiments, an IOU quantifies the extent of overlap of two boxes (e.g., two regions). In some embodiments, the IOU is higher when the region of overlap is greater. In certain embodiments, a match is found if a number of feature similarity is above a threshold. In certain embodiments, a match is found if a number of feature similarity is below and/or equal to a threshold. In some embodiments, a match includes a spatial match for a spatial relationship between two or more objects.

In some embodiments, a spatial match is found if two or more identified objects have a same relative location relationship as the spatial relationship for the two or more corresponding objects of interest, for example, stored in the spatial context repository, also referred to as the previous spatial relationship for the two or more corresponding objects of interest. In certain embodiments, a relative location relationship includes on-left, on-right, on-front, on-back, upper, lower, on-front-left, on-front-right, and/or the like. In some embodiments, a spatial relationship includes a distance. In some embodiments, a spatial match is found if a distance between two or more identified objects is within a distance threshold of a distance in the two or more corresponding spatial relationship. In certain embodiments, a spatial match is found if two or more identified objects have a same relative location relationship as the spatial relationship for the two or more corresponding objects of interest and have a distance within a distance threshold of a distance in the previous spatial relationship.

According to some embodiments, the object tracker 120 includes a template feature extraction model 122, search region feature extraction model 124, and/or similarity modeling 126. In certain embodiments, the template feature extraction model 122 can extract features (e.g., target characteristics) from one or more templates. In some embodiments, the template feature extraction model 122 can extract embeddings, also referred to as low-dimensional representations (e.g., vectors) from the one or more templates. In some embodiments, the template feature extraction model 122 can extract features and/or embeddings from the one or more templates. In some embodiments, extracted features are the same as extracted embeddings. In certain embodiments, extracted features are represented by embeddings (e.g., vector representations).

In certain embodiments, the search region feature extraction model 124 can extract features (e.g., target characteristics, background characteristics) of a search region which may have one or more templates within the search region. In some embodiments, a search region is a region of a certain size (e.g., with 200 square pixels) containing an identified object of interest. In certain embodiments, the search region is in a pixel space. In certain embodiments, the search region is relative to the size of the one or more template (e.g., 5 times the template bounding box size, such as 50 pixel×50 pixel if the template bounding box size is 10 pixel×10 pixel). In certain embodiments, a search region is a region of a certain size (e.g., with 200 square pixels) with the identified target of interest (e.g., the object of Track ID 1, the object of Track ID 2) at the center. In some embodiments, the search region feature extraction model 124 can extract embeddings from the search region. In some embodiments, extracted features are the same as extracted embeddings. In certain embodiments, extracted features are represented by embeddings (e.g., vector representations).

In certain embodiments, the object tracker 120 and/or the similarity model 126 determines one or more similarities (e.g., similarity metrics) between one or more templates and the search region to find target candidates in the search region. In some embodiments, the object tracker 120 and/or the similarity model 126 determines a similarity metric (e.g., a distance) between the one or more templates and the search region to identify the same objects (e.g., identified objects). In certain embodiments, the object tracker 120 and/or the similarity model 126 determines a similarity metric between the one or more templates and the search region to identify the same objects, where the similarity metric includes a spatial match of the one or more identified objects.

In certain embodiments, the object tracker 120 and/or the similarity model 126 determines the similarity metric using a similarity machine-learning model, for example, a regression similarity learning model, a classification similarity learning model, a ranking similarity learning model, an appearance model, and/or the like. In some embodiments, the object tracker 120 and/or the similarity model 126 determines the similarity metric between the template and an identified object using a Siamese neural network and/or the like. In certain embodiments, the object tracker 120 and/or the similarity model 126 determines a similarity distance between the template and an identified object. In some embodiments, the object tracker 120 and/or the similarity model 126 identifies the one or more objects of interest based on the corresponding templates and/or user inputs, then determines a spatial match of the identified one or more objects of interest. In certain embodiments, the object tracking system incorporates (e.g., encodes) the spatial match into an appearance matching network.

In some embodiments, the object tracker 120 and/or the similarity model 126 determines a spatial relationship between the one or more identified objects of interests. In certain embodiments, the object tracker 120 and/or the similarity model 126 compares the spatial relationship between the one or more identified objects of interests with a previous spatial relationship between the one or more identified objects of interests, for example, the previous spatial relationship stored in the spatial context repository 156 and/or 158. In certain embodiments, the object tracker 120 and/or the similarity model 126 determines whether there is a spatial match between the one or more identified objects of interests and the one or more corresponding spatial relationships, for example, spatial relationships stored in spatial context repository 156 and/or 158. In some embodiments, a spatial match is found if two or more identified objects have a same relative location relationship as the one or more spatial relationships in the data repository 150. In certain embodiments, a spatial match uses the spatial graph representing the spatial relationship.

In certain embodiments, a spatial match is found if a distance between two or more identified objects is within a distance threshold of a distance in the one or more spatial relationships. In some embodiments, a spatial match is found if two or more identified objects have a same relative location relationship as the one or more corresponding spatial relationships and have a distance within a distance threshold of a distance in the one or more spatial relationships.

In some embodiments, the object tracker 120 can use a motion model to predict a search region in a subsequent image frame (e.g., the image frame 110B). In certain embodiments, the object tracker 120 and/or the similarity model 126 can detect one or more objects of interest 114 (e.g., finding one or more matching bounding boxes, objects of interest 114A, objects of interest 114B, etc.) using one or more templates in the data repository 150.

In certain embodiments, the similarity model 126 can output embeddings extracted from an image and a template and/or extracted features. In some embodiments, extracted features are the same as extracted embeddings. In certain embodiments, extracted features are represented by embeddings (e.g., vector representations). In some embodiments, the similarity model 126 uses a template matching model to identify and/or locate an object of interest in the input image. In certain embodiments, the similarity model 126 includes one or more template matching models.

According to certain embodiments, the object tracker 120 includes a generic object detector 132 and a multi-object association module 134. In some embodiments, the generic object detector 132 is trained to identify generic objects, for example, objects of multiple classes. In certain embodiments, the multi-object association module 134 can produce associations between detections (e.g., detected objects). In some embodiments, the multi-object association module 134 can determine associations of objects between frames (e.g., image frames).

According to some embodiments, the object tracker 120 predicts and/or generates one or more identified objects 114B, also referred to as the tracker output 114B, for the image frame 110B. In certain embodiments, the image frame 110B is subsequent to or after the image frame 110A. In some embodiments, the generic object detector 132 and/or multi-object association 134 identifies one or more objects 116B, also referred to as one or more MOT identified objects, in the image frame 110B.

In certain embodiments, the generic object detector 132 and/or multi-object association 134 may run at a reduced frequency (e.g., every 5 or 10 frames) and/or run on demand, for example, to improve runtime efficiency. In some embodiments, the generic object detector 132 and/or multi-object association 134 may be triggered by one or more conditions (e.g., a demand). In certain embodiments, the one or more conditions include, for example, when retargeting is triggered, when the confidence score corresponding the tracker output 114 is low, when the movement between the current tracker output (e.g., the tracker output 114B) and the previous tracker output (e.g., the tracker output 114A) is large, and/or the like.

In some embodiments, for the short-term template repository 154 and the long-term template repository 152, the object tracking system 100 includes a separate feature extractor (e.g., a trained feature extractor) to extract features and/or embeddings from one or more images. In some embodiments, extracted features are the same as extracted embeddings. In certain embodiments, extracted features are represented by embeddings (e.g., vector representations).

In certain embodiments, the object tracking system 100 stores the extracted features and/or image crops in the data repository 150. In certain embodiments, the object tracking system 100 uses a first feature extractor for a first type of templates (e.g., long-term templates) and uses a second feature extractor for a second type of templates (e.g., short-term templates). In some embodiments, the first feature extractor is different from the second feature extractor. In certain embodiments, the first feature extractor is the same as the second feature extractor. In some embodiments, an image embedding, also referred to as an embedding, refers to a lower dimensional representation of an image, such as a vector representing the image.

According to certain embodiments, the fusion and quality predictor 140 determines, for each image frame or at least a part of the image frames, a spatial relationship identified between two or more identified objects in the tracker output 114. In some embodiments, the fusion and quality predictor 140 generates, for each image frame or at least a part of the image frames, the tracker output 145 based at least in part on the tracker output 114, one or more confidence scores corresponding the tracker output 114, a distance between the tracker output 114 and a tracker output of one or more previous frames, one or more tracker outputs from the previous frames, a distance between the tracker output 114 and one or more templates in the data repository 150, and/or the like.

In some embodiments, the fusion and quality predictor 140 generates, for each image frame or at least a part of the image frames, the tracker output 145 based at least in part on the tracker output 114, one or more confidence scores corresponding the tracker output 114, a distance between the tracker output 114 and a tracker output of one or more previous frames, one or more tracker outputs from the previous frames, one or more spatial relationships identified between two or more identified objects in the tracker output 114, spatial match based on the spatial relationships identified between two or more identified objects in the tracker output 114 and one or more corresponding spatial relationships stored in the spatial context repository 156 and/or 158, and/or the like.

In certain embodiments, the fusion and quality predictor 140 generates, for each image frame or at least a part of the image frames, the tracker output 145 based at least in part on the tracker output 114, one or more MOT detected objects 116, one or more confidence scores corresponding the tracker output 114 and the one or more MOT detected objects 116, a distance between the tracker output 114 and a tracker output of one or more previous frames, one or more tracker outputs from the previous frames, a distance between the tracker output 114 and one or more templates in the data repository 150, and/or the like.

In some embodiments, the fusion and quality predictor 140 evaluates the tracker output 114 based on one or more criteria (e.g., a number of factors, heuristics, etc.), for example, such as criteria on confidence, distance between the identified object of interest in the current frame and the previous frame, a distance of the tracker output 114 from one or more templates in the data repository 150, appearance similarity between the identified object of interest and one or more corresponding templates in the data repository 150, and/or the like. In certain embodiments, the object tracking system 100 and/or the fusion and quality predictor 140 determines a spatial relationship between the one or more identified objects in the tracker output 114. In some embodiments, the one or more criteria includes criteria on confidence score, a distance of the tracker output 114 from a tracker output in the previous frame, a distance of the tracker output 114 from one or more templates in the data repository 150, appearance similarity between the identified object of interest and one or more corresponding templates in the data repository 150, spatial match between the two or more identified objects in the tracker output and one or more corresponding spatial relationships (e.g., stored in the spatial context repository 156 and/or 158), and/or the like. In some embodiments, if the tracker output 114 meets the one or more criteria, the system 100 sets the tracker output 114 as the tracker output 145.

According to certain embodiments, the object tracking system 100 includes an update module 165 to update the template repository 152 and/or 154, the spatial context repository 156 and/or 158, and/or update the object tracker 120. In some embodiments, the fusion and quality predictor 140 and/or the update module 165 determines the IOU between the tracker output 114 and a corresponding template in the data repository 150. In some embodiments, if the tracker output 114 meets the one or more criteria, the object tracking system 100 and/or the update module 165 determines a spatial relationship between the one or more identified objects in the tracker output and/or stores the spatial relationship in the spatial context repository 158 and/or the data repository 150.

In certain embodiments, if the determined IOU is above the certain IOU threshold, the fusion and quality predictor 140 can add the tracker output 114 to the data repository 150 and/or the short-term template repository 152. In some embodiments, the fusion and quality predictor 140 determines feature similarity between the tracker output 114 and the corresponding template in the data repository 150. In certain embodiments, the fusion and quality predictor 140 determines whether feature similarity meets one or more criteria between the number of matching features between one or more features in and/or extracted from an identified object in the tracker output 114 and one or more features in and/or extracted from one or more corresponding templates, including one or more long-term templates and one or more short-term templates corresponding to the identified object.

According to some embodiments, the fusion and quality predictor 140 is configured to add, update, and/or remove templates from the data repository 150. In certain embodiments, for each frame (e.g., one image of a sequence of images) or at least a part of frames, if an identified object of two or more identified objects (e.g., corresponding to image potion in a bounding box, an image portion) is confident enough (e.g., above a certain threshold), the identified object and/or the associated image portion (e.g., an image region, a portion of an image) is identified as a template and/or added to the short-term template repository 154.

In some embodiments, the update module 165 performs a template update if the image embedding for the tracker output 114 (e.g., the tracker identified object, the tracker output 114A) is similar to the template embeddings in both the short-term template repository 154 and the long-term template repository 152, for example, to prevent update polluting the tracking model with the wrong target object (e.g., wrong target appearance). In certain embodiments, the update module 165 includes different implementations (e.g., implementations of strategies), for example, to strengthen or loosen the criteria for updating templates. In some embodiments, the object tracking system 100 can include a criterion on capturing the target object (e.g., target appearance) change in time and a criterion on not polluting the model with a wrong target object (e.g., target appearance). In certain embodiments, the update module 165 can include a criterion on appearance change in identifying new templates.

In certain embodiments, the update module 165 performs a spatial relationship update if the spatial relationship between two or more identified objects in the tracker output 114 is similar to (e.g., having a same relative location, within a distance range) the corresponding spatial relationship (e.g., the spatial relationship between two objects of interest having the same Track IDs). In some embodiments, the update module 165 performs a spatial relationship update by storing the determined spatial relationship between two or more identified objects in the tracker output 114 to the short-term spatial context repository 158.

In certain embodiments, the one or more templates and/or the one or more spatial relationships in the data repository 150 are used for the tracking model updates. In some embodiments, the one or more templates in the data repository 150 are weighted based on their recency (e.g., during training). In certain embodiments, a template in the long-term repository 152 is higher than a template in the short-term repository 154. In some embodiments, a most recent template in the long-term repository 152 is higher than a most recent template in the short-term repository 154. In some embodiments, the update module 165 assigns one or more weights to the one or more templates. In certain embodiments, the update module 165 may assign a weight to a new template based at least in part on an appearance similarity.

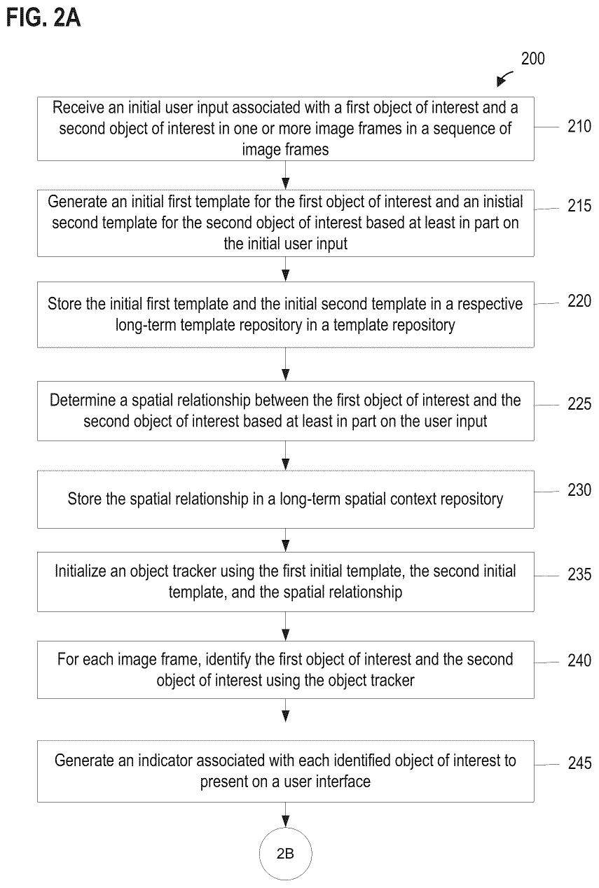

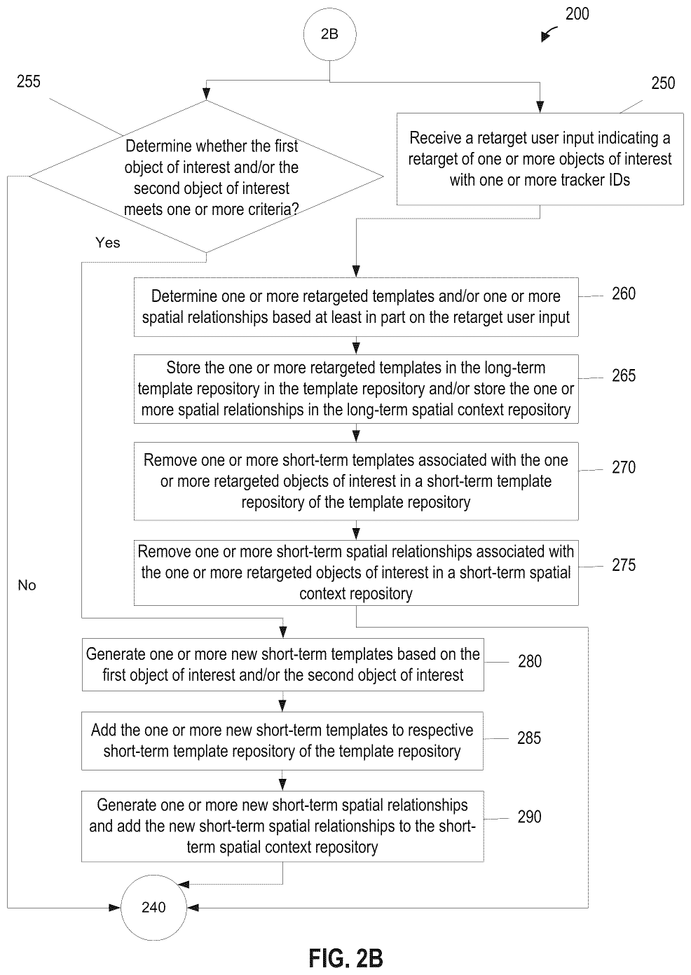

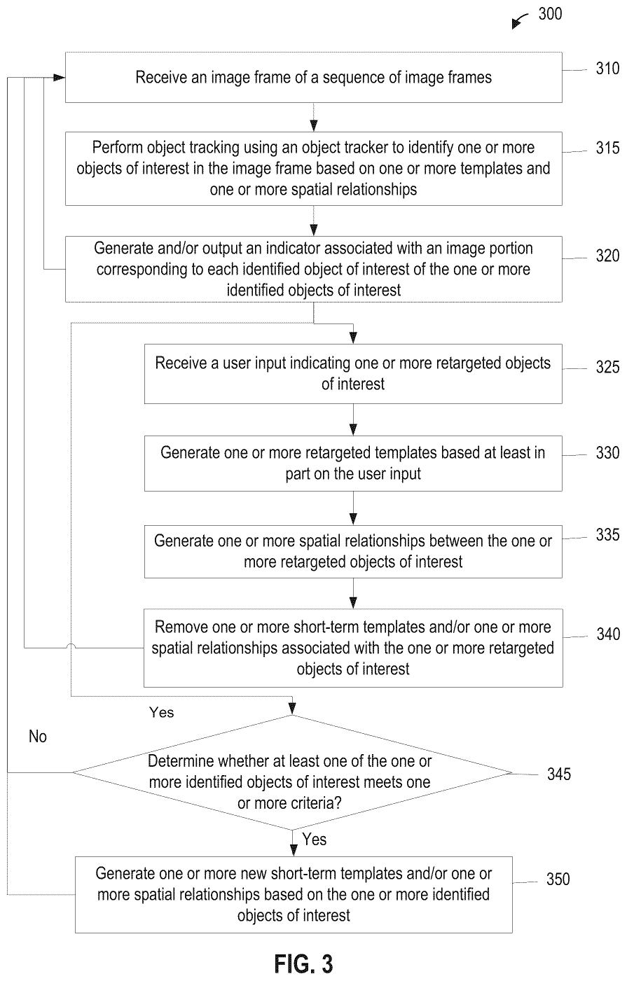

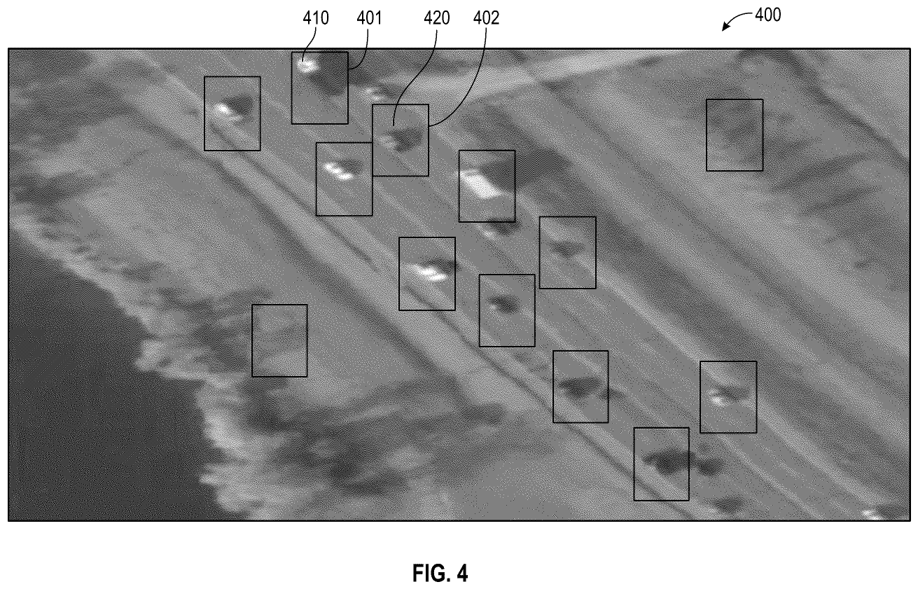

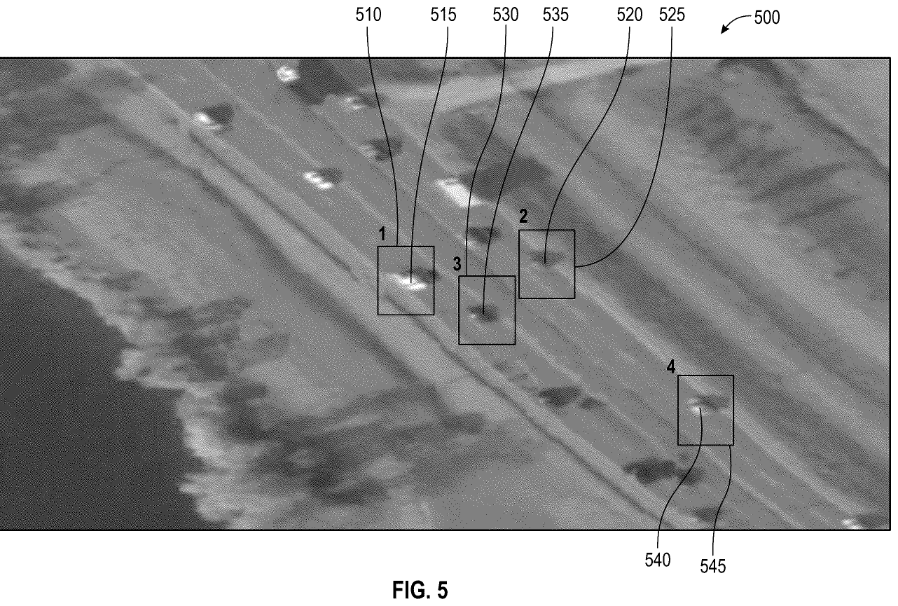

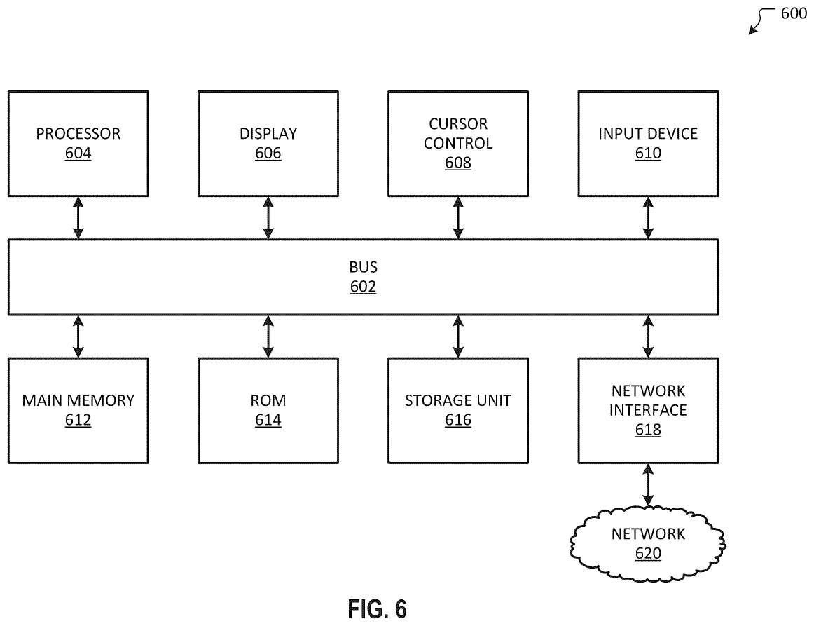

According to some embodiments, the object tracking system 100 includes a retargeting module 160 configured to receive one or more user inputs, for example, via a user interface 170. In some examples, the user interface 170 includes a graphical user interface (GUI), which can be displayed on a display of a computing device (e.g., display 606 of FIG. 6). In some examples, the GUI 170 may be an animated graphical user interface which is updated (e.g., animated) based on methods provided herein. For example, the GUI may be updated according to techniques illustrated and/or described with respect to least FIG. 1, FIG. 2A, FIG. 2B, FIG. 3, FIG. 4, and/or FIG. 5.

In certain embodiments, when retargeting happens, the short-term template repository 154 is emptied, reinitialized, and/or reset. For example, when retargeting happens, it means the object tracker 120 has already lost the target and the short-term template repository 154 may be contaminated with wrong template(s) (e.g., embeddings). In some embodiments, the update module 165 and/or the object tracking system 100 can generate a retargeting template 152B based at least in part on the user input (e.g., a click, a drawn bounding box, etc.). In certain embodiments, the retargeting template 152B is added to the long-term template repository 152.

In some embodiments, the object tracking system 100 determines one or more spatial relationships between the retargeting template 152B and one or more other objects of interest. In certain embodiments, the retargeting template 152B corresponds a retargeting object of interest, and the object tracking system 100 determines one or more spatial relationships between the retargeting object of interest and one or more other objects of interest. In some embodiments, the object tracking system 100 and/or the update module 165 stores the one or more spatial relationships in the spatial context repository, for example, the spatial context repository 156.

In some embodiments, the object tracking system 100 uses one or more templates in the long-term template repository 152 and data augmentations to update the object tracker 120 and/or train the tracker model (e.g., the online tracker model). In certain embodiments, the object tracking system 100 can reset or configure the object tracker 120 using the retargeting template 152B. In some embodiments, the object tracking system 100 can reset or configure the generic object detector 132 using the retargeting template 152B. In certain embodiments, the object tracking system 100 uses the retargeting template to predict new target appearance for the target object. In some embodiments, the retargeting template 152B being corresponding to the first object of interest, the object tracking system 100 and/or the update module 165 resets the short-term template repository 154 for the first object of interest, and/or the short-term spatial context repository 158 associated with the first object of interest. In certain embodiments, the retargeting template 152B being corresponding to the first object of interest, the object tracking system 100 and/or the update module 165 removes the one or more short-term templates in the short-term template repository 154 for the first object of interest, and/or the spatial relationships in the short-term spatial context repository 158 associated with the first object of interest.

In some embodiments, the object tracker 120 and/or the object tracking system 100 assigns a first weight to the initial template 152A and a second weight to the retargeting template 152B. In certain embodiments, the second weight is higher than the first weight. In some embodiments, the retargeting template 152B being corresponding to the first object of interest, the object tracker 120 and/or the object tracking system 100 assigns a first spatial weight to the spatial relationship between the first object of interest and the second object of interest, and assigns a second spatial weight to the spatial relationship between the retargeting template 152B and the second object of interest. In certain embodiments, the second spatial weight is higher than the first spatial weight.

In some embodiments, the repository 107 can include one or more templates (e.g., long-term templates, short-term templates), one or more spatial relationships, one or more confidence levels, one or more input images, one or more model outputs, one or more regions, one or more extracted features, one or more models, and/or the like. The repository 107 may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In certain embodiments, various components in the object tracking system 100 can interact with one another via a software interface. In some embodiments, a software interface includes an application programming interface (API), a web service interface, retrieving information from a file, retrieving information from a data repository, and/or the like. In some cases, various components in the object tracking system 100 can execute software or firmware stored in non-transitory computer-readable medium to implement various processing steps. Various components and processors of the object tracking system 100 can be implemented by one or more computing devices including, but not limited to, circuits, a computer, a cloud-based processing unit, a processor, a processing unit, a microprocessor, a mobile computing device, and/or a tablet computer. In some cases, various components of the object tracking system 100 (e.g., the object tracker 120, the fusion and quality predictor 140, the retargeting module 160, the update module 165, etc.) can be implemented on a shared computing device. Alternatively, a component of the object tracking system 100 can be implemented on multiple computing devices. In some implementations, various modules and components of the object tracking system 100 can be implemented as software, hardware, firmware, or a combination thereof. In some cases, various components of the object tracking system 100 can be implemented in software or firmware executed by a computing device.

Various components of the object tracking system 100 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

FIGS. 2A and 2B collectively illustrate a simplified diagram showing a method 200 for object tracking with retargeting inputs according to certain embodiments of the present disclosure. This diagram is merely an example. One of ordinary skill in the art would recognize many variations, alternatives, and modifications. The method 200 for object tracking with retargeting inputs includes processes 210, 215, 220, 225, 230, 235, 240, 245, 250, 255, 260, 265, 270, 275, 280, 285, and 290. Although the above has been shown using a selected group of processes for the method 200 for object tracking with retargeting inputs, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In some embodiments, some or all processes (e.g., steps) of the method 200 are performed by a system (e.g., the computing system 600). In certain examples, some or all processes (e.g., steps) of the method 200 are performed by a computer and/or a processor directed by a code. For example, a computer includes a server computer and/or a client computer (e.g., a personal computer). In some examples, some or all processes (e.g., steps) of the method 200 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to some embodiments, at process 210, the system receives an initial user input associated with a first object of interest and a second object of interest in one or more image frames of a sequence of image frames. In certain embodiments, a user input is received via a user interface and/or a software interface. In some embodiments, the user input is a drawn bounding box. In certain embodiments, the user input is a click, for example, on an image frame. In certain embodiments, the initial user input includes a first user input associated with the first object of interest and a second user input associated with the second object of interest. In some embodiments, the first user input is associated with a first image frame and the second user input is associated with a second image frame different from the first image frame. In certain embodiments, the first user input and the second user input are associated with a same image frame.

In some examples, users (e.g., users 180 of FIG. 1) can be prompted to provide the user input. In some embodiments, the users can be prompted to provide the user input at regular intervals. In some embodiments, the users 180 can be prompted to provide feedback at irregular intervals. In some embodiments, the users 180 can provide feedback without being prompted (e.g., between adjacent prompting instances, before a prompting instance has occurred, and/or after a prompting instance has occurred).

In certain embodiments, the bounding box is a closed shape. In some examples, the bounding box is a regular polygon, such as a circle, square, rectangle, diamond, etc. In some examples, the bounding box is an irregular polygon (e.g., a shape that does not have equal sides or angles). Examples of regular and/or irregular polygons should be recognized by those of ordinary skill in the art.

In some embodiments, the user input is generated by a machine-learning model (e.g., a language model). In some examples, the machine learning model is an LM that may include an algorithm, rule, model, and/or other programmatic instructions that can predict the probability of a sequence of words. In some embodiments, an LM may, given a starting text string (e.g., one or more words), predict the next word in the sequence. In certain embodiments, an LM may calculate the probability of different word combinations based on the patterns learned during training (based on a set of text data from books, articles, websites, audio files, etc.). In some embodiments, an LM may generate many combinations of one or more next words (and/or sentences) that are coherent and contextually relevant. In certain embodiments, an LM can be an advanced artificial intelligence algorithm that has been trained to understand, generate, and manipulate language. In some embodiments, an LM can be useful for natural language processing, including receiving natural language prompts and providing natural language responses based on the text on which the model is trained. In certain embodiments, an LM may include an n-gram, exponential, positional, neural network, and/or other type of model.

In examples, the machine learning model is an LLM, which was trained on a larger data set and has a larger number of parameters (e.g., billions of parameters) compared to a regular LM. In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pre-trained Transformer 3 (GPT-3) model, a GPT 3.5-turbo model, a Claude model, a command-xlang model, a bidirectional encoder representations from transformers (BERT) model, a pathways language model (PaLM) 2, and/or the like. Thus, a prompt describing an object to be tracked may be provided for processing by the LLM, which thus generates a recommendation accordingly.

According to certain embodiments, at process 215, the system generates an initial first template for the first object of interest and an initial second template for the second object of interest based at least in part on the initial user input. In some embodiments, the initial first template and/or the initial second template is the image portion in the bounding box of the initial user input. In certain embodiments, the initial first template and/or the initial second template is associated with metadata, for example, time (temporal) and/or location (e.g., geographical) information related to the initial image frame and/or the image portion. In some examples, the location metadata may include coordinates, such as a latitude value and/or longitude value, rectangular coordinates, and/or polar coordinates. In some embodiments, the initial first template and/or the initial second template includes corresponding metadata. In certain embodiments, the initial first template and/or the initial second template include extracted features associated with the corresponding image portion.

According to some embodiments, at process 220, the system stores the initial first template and the initial second template in a long-term template repository (e.g., the long-term template repository 152) in a template repository (e.g., the data repository 150). In certain embodiments, the initial first template is stored in a first long-term template repository. In some embodiments, the initial second template is stored in a second long-term template repository. In certain embodiments, image templates are classified into two or more categories (e.g., types), for example, templates generated based on model outputs, templates generated based on user inputs. In some embodiments, templates generated based on model outputs are referred to as short-term templates. In certain embodiments, templates generated based on user inputs are referred to as long-term templates. For example, the initial template generated based on the initial user input is a long-term template. In some embodiments, each template is associated with a weight when the template is used for object tracking. In certain embodiments, a short-term template has a weight lower than a weight of a long-term template.

In some embodiments, the data repository includes two or more template repositories and each template repository includes templates in a category, for example, a template category of templates generated based on model outputs, a template category of templates generated based on user inputs. In some embodiments, short-term templates (e.g., templates generated based on model outputs) are stored in a short-term template repository (e.g., the short-term template repository 154) of the data repository. In certain embodiments, long-term templates (e.g., templates generated based on user inputs) are stored in the long-term template repository. In some embodiments, each object of interest has a respective long-term template repository and/or short-term template repository.

According to certain embodiments, at process 225, the system determines a spatial relationship between the first object of interest and the second object of interest based at least in part on the user input. In some embodiments, a spatial relationship includes a spatial encoding of locations of two or more objects. In certain embodiments, the spatial relationship includes a spatial graph. In some embodiments, a spatial graph includes one or more nodes of spatial locations, usually given by coordinates in one, two or three dimensions. In certain embodiments, the spatial relationship includes relative positions of two or more objects. In some embodiments, at process 230, the system stores the spatial relationship in a long-term spatial context repository (e.g., spatial repository 156). In certain embodiments, the system stores the spatial relationship in a spatial context repository.

According to some embodiments, at process 235, the system initializes an object tracker using the first initial template, the second initial template and the spatial relationship. In some embodiments, the object tracker is initialized by three or more initial templates and two or more spatial relationships. In certain embodiments, the object uses a template matching model. In some embodiments, the object tracker extracts features from the one or more initial templates and uses the template matching model with the extracted features.

According to some embodiments, at process 240, for each image frame, the system identifies the first object of interest and the second object of interest using the object tracker. In some embodiments, the object tracker identifies the one or more objects of interest by matching the one or more objects of interest with respective templates and/or one or more spatial relationships between the one or more objects of interest.

According to some embodiments, the object tracker includes a template feature extraction model, search region feature extraction model, and/or similarity modeling. In certain embodiments, the template feature extraction model can extract features (e.g., target characteristics) from one or more templates. In some embodiments, the template feature extraction model can extract embeddings, also referred to as low-dimensional representations (e.g., vectors) from the one or more templates. In some embodiments, the template feature extraction model can extract features and/or embeddings from the one or more templates.

In certain embodiments, the search region feature extraction model can extract features (e.g., target characteristics, background characteristics) from the one or more templates within a search region. In some embodiments, a search region is a region of a certain size (e.g., with 200 square pixels) containing an identified target of interest. In certain embodiments, a search region is a region of a certain size (e.g., with 200 square pixels) with the identified target of interest (e.g., the object of Track ID 1, the object of Track ID 2) at the center. In some embodiments, the search region feature extraction model can extract embeddings from the search region.

In certain embodiments, the object tracker and/or the similarity model determines one or more similarities (e.g., similarity metrics) between one or more templates and the search region to find target candidates in the search region. In some embodiments, the object tracker and/or the similarity model determines a similarity metric (e.g., a distance) between the one or more templates and the search region to identify the same objects (e.g., identified objects). In certain embodiments, the object tracker and/or the similarity model determines a similarity metric between the one or more templates and the search region to identify the same objects, where the similarity metric includes a spatial match of the one or more identified objects.

In certain embodiments, the object tracker and/or the similarity model determines the similarity metric using a similarity machine-learning model, for example, a regression similarity learning model, a classification similarity learning model, a ranking similarity learning model, an appearance model, and/or the like. In some embodiments, the object tracker and/or the similarity model determines the similarity metric between the template and an identified object using a Siamese neural network and/or the like. In certain embodiments, the object tracker and/or the similarity model determines a similarity distance between the template and an identified object. In some embodiments, the object tracker and/or the similarity model identifies the one or more objects of interest based on the corresponding templates and/or user inputs, then determines a spatial match of the identified one or more objects of interest. In certain embodiments, the object tracking system incorporates (e.g., encodes) the spatial match into an appearance matching network.

In some embodiments, the object tracker and/or the similarity model determines a spatial relationship between the one or more identified objects of interests. In certain embodiments, the object tracker and/or the similarity model compares the spatial relationship between the one or more identified objects of interests with a previous spatial relationship between the one or more objects of interest, for example, stored in a spatial context repository. In certain embodiments, the object tracker and/or the similarity model determines whether there is a spatial match between the one or more identified objects of interests and the one or more corresponding spatial relationships, for example, spatial relationships stored in spatial context repository. In some embodiments, a spatial match is found if two or more identified objects have a same relative location relationship as the one or more spatial relationships in the data repository. In certain embodiments, a spatial match uses the spatial graph representing the spatial relationship.

In certain embodiments, a spatial match is found if a distance between two or more identified objects is within a distance threshold of a distance in the one or more spatial relationships. In some embodiments, a spatial match is found if two or more identified objects have a same relative location relationship as the one or more corresponding spatial relationships and have a distance within a distance threshold of a distance in the one or more spatial relationships.

In some embodiments, a match is found when two images (e.g., two image areas, two image sections, two set of features extracted from two images), such as a bounding box representing an identified object by the object tracker and one or more object templates, are within a certain IOU (intersection of union) threshold. In certain embodiments, the IOU threshold is a predetermined IOU threshold. In certain embodiments, an IOU quantifies the extent of overlap of two boxes (e.g., two regions). In some embodiments, the IOU is higher when the region of overlap is greater. In certain embodiments, a match is found if a number of feature similarity is above a threshold. In certain embodiments, a match is found if a number of feature similarity is less than and/or equal to a threshold. In some embodiments, a match includes a spatial match for a spatial relationship between two or more objects.

In certain embodiments, the system determines an identified spatial relationship between the identified first object of interest and the identified second object of interest. In some embodiments, the system determines a confidence score associated with the identified first object of interest and the identified second object of interest based at least in part on the identified spatial relationship and the spatial relationship stored in a data repository. In certain embodiments, the confidence score is at a low level if the identified spatial relationship indicates an opposite relative location from a relative location indicated by the spatial relationship. In some embodiments, the relative location comprises a relative location from a reference object including at least one of a left side of the reference object, a right side of the reference object, in front of the reference object, or behind the reference object.

According to some embodiments, at process 245, the system generates an indicator associated with each identified object of interest to present on a user interface (e.g., the user interface 170 of FIG. 1). In certain embodiments, the indicator indicates a confidence level (e.g., a confidence level of a tracking or object prediction) associated with the identified object of interest. In some embodiments, an indicator includes a first characteristic representing a high confidence level and a second characteristic representing a low confidence level. In certain embodiments, the indicator is in a closed shape (e.g., a rectangle, a circle, an oval, an irregular polygon, etc.). In some examples, an indicator is a closed shape with a solid line and/or a first weight for an identified object having a high confidence level. In certain examples, an indicator is a closed shape with a dashed line and/or a second weight for an identified object having a low confidence level. In some embodiments, the one or more indications include indications of at least a part of the set of detected objects each having a confidence level higher than a threshold. In certain embodiments, the threshold is a predetermined threshold (e.g., previously specified by a user, developer, policy, manufacturer, organization, etc.).

FIG. 4 illustrates an example user interface 400 with indicators (e.g., a first indicator 401 and a second indicator 402) associated with identified objects of interest (e.g., a first object of interest 410 and a second object of interest 420).

According to certain embodiments, at process 250, the system receives a retarget user input indicating a retarget of one or more objects of interest with corresponding track IDs. In some embodiments, a user is prompted to provide the user input. In some embodiments, the user is prompted to provide the user input at regular intervals. In some embodiments, the user is prompted to provide the user input in response to an output of a process. In some embodiments, the user is prompted to provide the user input at irregular intervals. In some embodiments, the user provides feedback without being prompted.

In some embodiments, the user input is generated by a machine-learning model (e.g., a language model). In some examples, the machine learning model is an LM that may include an algorithm, rule, model, and/or other programmatic instructions that can predict the probability of a sequence of words. In some embodiments, an LM may, given a starting text string (e.g., one or more words), predict the next word in the sequence. In certain embodiments, an LM may calculate the probability of different word combinations based on the patterns learned during training (based on a set of text data from books, articles, websites, audio files, etc.). In some embodiments, an LM may generate many combinations of one or more next words (and/or sentences) that are coherent and contextually relevant. In certain embodiments, an LM can be an advanced artificial intelligence algorithm that has been trained to understand, generate, and manipulate language. In some embodiments, an LM can be useful for natural language processing, including receiving natural language prompts and providing natural language responses based on the text on which the model is trained. In certain embodiments, an LM may include an n-gram, exponential, positional, neural network, and/or other type of model.

In examples, the machine learning model is an LLM, which was trained on a larger data set and has a larger number of parameters (e.g., billions of parameters) compared to a regular LM. In certain embodiments, an LLM can understand more complex textual inputs and generate more coherent responses due to its extensive training. In certain embodiments, an LLM can use a transformer architecture that is a deep learning architecture using an attention mechanism (e.g., which inputs deserve more attention than others in certain cases). In some embodiments, a language model includes an autoregressive language model, such as a Generative Pre-trained Transformer 3 (GPT-3) model, a GPT 3.5-turbo model, a Claude model, a command-xlang model, a bidirectional encoder representations from transformers (BERT) model, a pathways language model (PaLM) 2, and/or the like. Thus, a prompt describing an object to be tracked may be provided for processing by the LLM, which thus generates a recommendation accordingly.

In some embodiments, the retarget user input is a drawn bounding box (e.g., a closed shape, which may be a regular polygon or an irregular polygon) or a selection (e.g., click). In certain embodiments, the retarget user input indicates a change to a track ID. In some embodiments, the retarget user input includes inputs indicating a retarget of two or more objects of interest.

FIG. 5 illustrates an example user interface 500 with retarget user input, where some indications of identified objects of interest are removed and some identified objects of interest are provided with track IDs (e.g., 1, 2, 3, 4). For example, FIG. 5 illustrates a first identified object of interest 510, a second identified object of interest 520, a third identified object of interest 530, and a fourth identified object of interest 540. The first identified object of interest 510 is enclosed by a first bounding box 515 (e.g., a first indication). The second identified object of interest 520 is enclosed by a second bounding box 525 (e.g., a second indication). The third identified object of interest 530 is enclosed by a third bounding box 535 (e.g., a third indication). The fourth identified object of interest 540 is enclosed by a fourth bounding box 545 (e.g., a fourth indication).

According to some embodiments, at process 260, the system determines one or more retargeted templates and/or one or more spatial relationships based at least in part on the retarget user input. In certain embodiments, at process 265, the system stores the retargeted template in the long-term template repository in the template repository and/or stores the one or more spatial relationships in the long-term spatial context repository. In some embodiments, the system uses one or more templates in the long-term template repository and data augmentations to update the object tracker and/or train the object tracker (e.g., the online tracker model). In certain embodiments, the system uses the one or more retargeting templates to predict new target appearance for the objects of interest (e.g., target object). In some embodiments, the system assigns a first weight to the initial template of an object of interest and a second weight to the retargeting template of the object of interest. In certain embodiments, the second weight is higher than the first weight.

According to certain embodiments, at process 270, the system removes one or more templates associated with the one or more retargeted objects of interest in a short-term template repository of the template repository. In some embodiments, at process 275, the system removes one or more short-term spatial relationships associated with the one or more retargeted objects of interest in a short-term spatial context repository. In certain embodiments, the retarget user input indicates a retarget of a first object of interest with a first track ID. In some embodiments, the system removes one or more short-term templates associated with the first object of interest with the first track ID. In certain embodiments, the system removes one or more short-term spatial relationships associated with the first object of interest with the first track ID. In some embodiments, the system removes one or more short-term spatial relationships between the first object of interest with the first track ID and a second object of interest with a second track ID. In certain embodiments, the system removes one or more short-term spatial relationships between the first object of interest with the first track ID and a second object of interest with a second track ID and one or more short-term spatial relationships between the first object of interest with the first track ID and a third object of interest with a third track ID.

In certain embodiments, the retarget user input indicates a retarget of a first object of interest with a first track ID and a second object of interest with a second track ID. In some embodiments, the system removes one or more short-term templates associated with the first object of interest with the first track ID in a first short-term template repository. In certain embodiments, the system removes one or more short-term templates associated with the first object of interest with the second track ID in a second short-term template repository. In some embodiments, the system removes one or more short-term spatial relationships associated with the first object of interest with the first track ID. In certain embodiments, the system removes one or more short-term spatial relationships associated with the second object of interest with the second track ID.

In some embodiments, when retargeting happens, the short-term template repository is emptied, and/or reset. For example, when retargeting happens, it means the object tracker has already lost the target and the short-term template repository may be contaminated with wrong template(s) (e.g., embeddings). In some embodiments, an online training step for the object tracker is triggered with the user providing a retargeting template via a user input (e.g., a click) and/or receiving a retarget user input. In certain embodiments, the system goes to process 240 to process a subsequent image frame.

According to certain embodiments, at process 255, the system determines whether the first object of interest and/or the second object of interest, collectively, the tracker output, meets one or more criteria. In some embodiments, the system evaluates the first object of interest and/or the second object of interest based on one or more criteria (e.g., a number of factors, heuristics, etc.), for example, such as criteria on confidence, distance between the identified object of interest in the current frame and the previous frame, a distance of the tracker output from one or more templates, appearance similarity between the identified object of interest and one or more corresponding templates, and/or the like. In certain embodiments, the system determines a spatial relationship between the one or more identified objects. In some embodiments, the one or more criteria includes criteria on confidence score, a distance of the object of interest from the object of interest with same track ID in the previous frame, a distance of the object of interest from one or more templates, appearance similarity between the identified object of interest and one or more corresponding templates, spatial match between the two or more identified objects in the tracker output and one or more corresponding spatial relationships, and/or the like.

In certain embodiments, the one or more criteria include a criterion of similarity of the object of interest and/or its embedding and respective template. In some embodiments, the criterion of similarity includes a similarity threshold. In certain embodiments, the criteria include a criterion of confidence level above a threshold (e.g., 50%, 60%, 80%, etc.). In some embodiments, the criteria include a criterion of confidence level above a predetermined threshold. In some embodiments, the system determines the IOU between the first object of interest and/or the second object of interest and a corresponding template. In certain embodiments, the one or more criteria include a criterion of an IOU threshold.

In certain embodiments, if the one or more criteria is not met (e.g., at least one criterion of the one or more criteria is not met), the system goes to process 240. In some embodiments, if the one or more criteria is met, at process 280, the system generates one or more new short-term templates based on the first object of interest and/or the second object of interest. In certain embodiments, at process 285, the system adds the one or more new short-term templates to respective short-term template repository of the template repository. In some embodiments, at process 290, the system generates one or more new short-term spatial relationships and adds the one or more new short-term spatial relationships to the short-term spatial context repository. In certain embodiments, the system goes to process 240.

FIG. 3 collectively is a simplified diagram showing a method 300 for multiple-object tracking according to certain embodiments of the present disclosure. This diagram is merely an example. One of ordinary skill in the art would recognize many variations, alternatives, and modifications. The method 300 for multiple-object tracking with retargeting inputs includes processes 310, 315, 320, 325, 330, 335, 340, 345, and 350. Although the above has been shown using a selected group of processes for the method 300 for multiple-object tracking, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In some embodiments, some or all processes (e.g., steps) of the method 300 are performed by a system (e.g., the computing system 600). In certain examples, some or all processes (e.g., steps) of the method 300 are performed by a computer and/or a processor directed by a code. For example, a computer includes a server computer and/or a client computer (e.g., a personal computer). In some examples, some or all processes (e.g., steps) of the method 300 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to some embodiments, at process 310, the system receives an image frame of a sequence of image frames. In some embodiments, the image frame is received from an image sensor (e.g., a still camera, a video camera, a satellite). In certain embodiments, at process 315, the system performs object tracking using an object tracker to identify one or more objects of interest in the image frame based upon one or more templates and one or more spatial relationships, for example, templates and/or spatial relationships stored in a data repository. In some embodiments, the one or more templates include one or more templates generated based on user inputs (e.g., long-term templates) for a respective object of interest. In certain embodiments, the one or more templates include one or more templates generated based on model tracking and/or inference (e.g., short-term templates) for a respective object of interest. In some embodiments, the one or more templates are stored in a template repository.

In certain embodiments, the template repository includes one or more short-term template repositories storing one or more short-term templates and one or more long-term template repositories storing one or more long-term templates. In some embodiments, the system identifies one or more objects of interest using a similarity model (e.g., a template matching model). In some embodiments, the latest long-term template has a higher weight than the weight of the latest short-term template for a respective object of interest.

In certain embodiments, the system uses an identified object of interest in an image frame and a motion model to predict a search region for a subsequent image frame. In some embodiments, the object tracker uses the predicted search region and one or more templates (e.g., weighted templates) to identify the object of interest in the subsequent image frame. In some embodiments, the object tracker uses a similarity model (e.g., a template matching model) to identify and/or locate an image portion associated with the object of interest in the image frame. In certain embodiments, the object tracker uses one or more similarity models (e.g., an appearance model).

According to certain embodiments, at process 320, the system generates and/or outputs an indicator associated with an image portion corresponding to each identified object of interest of the one or more identified objects of interest. In some embodiments, the system determines one or more similarities (e.g., similarity metrics) between a template and the identified object of interest. In some embodiments, the system determines a similarity metric (e.g., a distance) between the template and the identified object of interest. In certain embodiments, the system determines the similarity metric using a similarity machine-learning model, for example, a regression similarity learning model, a classification similarity learning model, a ranking similarity learning model, and/or the like. In some embodiments, the system determines the similarity metric between the template and the identified object of interest using a Siamese neural network and/or the like. In certain embodiments, the system determines a similarity distance between the template and the identified object of interest.

According to some embodiments, the system determines a confidence level for the identified object of interest and/or the corresponding image portion. In some embodiments, the system determines a confidence level for the identified object of interest and/or the corresponding image portion based at least in part on the one or more determined similarities. In certain embodiments, the system processes subsequent image frames in a recursive process, for example, go back to process 310.

According to certain embodiments, at process 325, the system receives a user input indicating one or more retargeted objects of interest. Therefore, in some embodiments, the user input is associated with the object of interest. In some embodiments, the user input indicates an identified image portion in the received image frame of process 310. In some embodiments, the retarget user input is one or more drawn bounding boxes (e.g., a closed shape), one or more selections (e.g., clicks), and/or one or more track IDs.

In some embodiments, at process 330, the system generates one or more retargeted templates based at least in part on the user input (e.g., based at least in part on the identified image portion indicated by and/or associated with the user input). In certain embodiments, the system stores the retargeted template in the long-term template repository in the template repository. In some embodiments, the system uses one or more templates in the long-term template repository and data augmentations to update and/or train one or more models. In certain embodiments, the system uses the retargeting template to predict a new target appearance for one or more objects of interest (e.g., target objects). In some embodiments, the system assigns a first weight to one or more existing long-term templates and a second weight to the one or more retargeting templates. In certain embodiments, the second weight is higher than the first weight.

In certain embodiments, at process 335, the system generates one or more spatial relationships between the one or more retargeted objects of interest. In some embodiments, the system stores the one or more retargeted templates in the long-term template repository in the template repository. In certain embodiments, the system stores the one or more spatial relationships in the long-term spatial context repository.

In certain embodiments, at process 340, the system removes one or more short-term templates and/or one or more spatial relationships associated with the one or more retargeted objects of interest. In some embodiments, when retargeting happens, the short-term template repository and/or the short-term spatial relationships is emptied, and/or reset. For example, when retargeting happens, it means the object tracker has already lost the target and the short-term template repository may be contaminated with wrong template(s) (e.g., embeddings). In some embodiments, an online training step for the object tracker is triggered with the user providing a retargeting template via a user input (e.g., a click) and/or receiving a retarget user input. In some embodiments, the system uses one or more templates in the long-term template repository and data augmentations to update the object tracker and/or train the object tracker (e.g., the online tracker model). In certain embodiments, the system uses the retargeting template to predict new target appearance for the object of interest (e.g., target object). In some embodiments, the system assigns a first weight to an existing long-term template and a second weight to the retargeting template. In certain embodiments, the second weight is higher than the first weight. In some embodiments, the system goes back to the process 310 for the subsequent image frame.

According to certain embodiments, at process 345, the system determines whether at least one of the one or more identified objects of interest meet one or more criteria. In certain embodiments, the system determines a spatial relationship between the one or more identified objects. In some embodiments, the one or more criteria includes criteria on confidence score, a distance of the object of interest from the object of interest with same track ID in the previous frame, a distance of the object of interest from one or more templates, appearance similarity between the identified object of interest and one or more corresponding templates, spatial match between the two or more identified objects in the tracker output and one or more corresponding spatial relationships, and/or the like.

In certain embodiments, the one or more criteria include a criterion of similarity of the object of interest and/or its embedding and respective template. In some embodiments, the criterion of similarity includes a similarity threshold. In certain embodiments, the criteria include a criterion of confidence level above a threshold (e.g., 50%, 60%, 80%, etc.). In some embodiments, the criteria include a criterion of confidence level above a predetermined threshold. In some embodiments, the system determines the IOU between the first object of interest and/or the second object of interest and a corresponding template. In certain embodiments, the one or more criteria include a criterion of an IOU threshold.

According to some embodiments, at process 350, if at least one of the one or more identified objects of interest meets the one or more criteria, the system generates one or more new short-term templates and/or one or more spatial relationships based on the one or more identified objects of interest. In certain embodiments, if the one or more criteria are not met, the system goes back to process 310 for the subsequent image frame. In some embodiments, the new short-term template includes one or more features and/or embeddings extracted from the image portion. In certain embodiments, the system adds the new short-term template to the short-term template repository of the template repository. In some embodiments, the system assigns a new weight associated with the new short-term template. In certain embodiments, the weight of the new short-term template is higher than one or more existing short-term templates, for example, the one or more templates in the short-term template repository. In some embodiments, the system goes back to the process 310 for the subsequent image frame.

FIG. 6 is a simplified diagram showing a computing system for implementing a system 600 for object tracking with retargeting inputs in accordance with at least one example set forth in the disclosure. This diagram is merely an example, which should not unduly limit the scope of the claims. One of ordinary skill in the art would recognize many variations, alternatives, and modifications.

The computing system 600 includes a bus 602 or other communication mechanism for communicating information, a processor 604, a display 606, a cursor control component 608, an input device 610, a main memory 612, a read only memory (ROM) 614, a storage unit 616, and a network interface 618. In some embodiments, some or all processes (e.g., steps) of the methods 200 and/or 300 are performed by the computing system 600. In some examples, the bus 602 is coupled to the processor 604, the display 606, the cursor control component 608, the input device 610, the main memory 612, the read only memory (ROM) 614, the storage unit 616, and/or the network interface 618. In certain examples, the network interface is coupled to a network 620. For example, the processor 604 includes one or more general purpose microprocessors. In some examples, the main memory 612 (e.g., random access memory (RAM), cache and/or other dynamic storage devices) is configured to store information and instructions to be executed by the processor 604. In certain examples, the main memory 612 is configured to store temporary variables or other intermediate information during execution of instructions to be executed by processor 604. For example, the instructions, when stored in the storage unit 616 accessible to processor 604, render the computing system 600 into a special-purpose machine that is customized to perform the operations specified in the instructions. In some examples, the ROM 614 is configured to store static information and instructions for the processor 604. In certain examples, the storage unit 616 (e.g., a magnetic disk, optical disk, or flash drive) is configured to store information and instructions.

In some embodiments, the display 606 (e.g., a cathode ray tube (CRT), an LCD display, or a touch screen) is configured to display information to a user of the computing system 600. In some examples, the input device 610 (e.g., alphanumeric and other keys) is configured to communicate information and commands to the processor 604. For example, the cursor control component 608 (e.g., a mouse, a trackball, or cursor direction keys) is configured to communicate additional information and commands (e.g., to control cursor movements on the display 606) to the processor 604.

According to certain embodiments, a method for user-assisted multi-object tracking is provided. The method includes: receiving a first image frame in a sequence of image frames: performing object tracking using an object tracker to identify a first object of interest and a second object of interest in the first image frame based at least in part on one or more first templates associated with the first object of interest, one or more second templates associated with the second object of interest, and a spatial relationship between the first object of interest and the second object of interest; and outputting a first indicator associated with a first image portion corresponding to the identified first object of interest: outputting a second indicator associated with a second image portion corresponding to the identified second object of interest, wherein the method is performed using one or more processors. For example, the method is implemented according to at least FIG. 1, FIGS. 2A, FIG. 2B, FIG. 3, FIG. 4, and/or FIG. 5.

In some embodiments, the method further comprises: receiving a user input associated with the first object of interest, the user input indicating an identified image portion in a second image frame in the sequence of image frames; and generating a retargeted template based at least in part on the identified image portion. In certain embodiments, the spatial relationship is a first spatial relationship. In some embodiments, the method further comprises: determining a second spatial relationship between the first object of interest and the second object of interest based at least in part on the retargeted template. In certain embodiments, the method further comprises: removing the first spatial relationship from a data repository; and storing the second spatial relationship in the data repository.

In some embodiments, the method further comprises: storing the retargeted template to a long-term template repository of the template repository. In certain embodiments, the spatial relationship includes a spatial graph. In some embodiments, the method further comprises: determining an identified spatial relationship between the identified first object of interest and the identified second object of interest; and determining a confidence score associated with the identified first object of interest and the identified second object of interest based at least in part on the identified spatial relationship and the spatial relationship stored in a data repository. In certain embodiments, the confidence score is at a low level if the identified spatial relationship indicates an opposite relative location from a relative location indicated by the spatial relationship. In some embodiments, the opposite relative location comprises a relative location from a reference object including at least one of a left side of the reference object, a right side of the reference object, in front of the reference object, or behind the reference object. In certain embodiments, the method further comprises: determining whether at least one of the identified first object of interest or the identified second object of interest satisfies one or more criteria; and generating a template based on the at least one of the identified first object of interest or the identified second object of interest, wherein the generated template is a short-term template.

According to certain embodiments, a system for user-assisted multi-object tracking is provided. The system includes at least one processor and at least one memory storing instructions that, when executed by the at least one processor, causes the system to perform a set of operations, the set of operations comprising: receiving a first image frame in a sequence of image frames: performing object tracking using an object tracker to identify a first object of interest and a second object of interest in the first image frame based at least in part on one or more first templates associated with the first object of interest, one or more second templates associated with the second object of interest, and a spatial relationship between the first object of interest and the second object of interest; and outputting a first indicator associated with a first image portion corresponding to the identified first object of interest: outputting a second indicator associated with a second image portion corresponding to the identified second object of interest. For example, the system is implemented according to at least FIG. 1, FIGS. 2A, FIG. 2B, FIG. 3, FIG. 4, FIG. 5, and/or FIG. 6.

In some embodiments, the set of operations further includes: receiving a user input associated with the first object of interest, the user input indicating an identified image portion in a second image frame in the sequence of image frames; and generating a retargeted template based at least in part on the identified image portion. In certain embodiments, the spatial relationship is a first spatial relationship. In some embodiments, the set of operations further includes: determining a second spatial relationship between the first object of interest and the second object of interest based at least in part on the retargeted template. In certain embodiments, the set of operations further includes: removing the first spatial relationship from a data repository; and storing the second spatial relationship in the data repository.

In some embodiments, the set of operations further includes: storing the retargeted template to a long-term template repository of the template repository. In certain embodiments, the spatial relationship includes a spatial graph. In some embodiments, the set of operations further includes: determining an identified spatial relationship between the identified first object of interest and the identified second object of interest; and determining a confidence score associated with the identified first object of interest and the identified second object of interest based at least in part on the identified spatial relationship and the spatial relationship stored in a data repository. In certain embodiments, the confidence score is at a low level if the identified spatial relationship indicates an opposite relative location from a relative location indicated by the spatial relationship. In some embodiments, the opposite relative location comprises a relative location from a reference object including at least one of a left side of the reference object, a right side of the reference object, in front of the reference object, or behind the reference object. In certain embodiments, the set of operations further includes: determining whether at least one of the identified first object of interest or the identified second object of interest satisfies one or more criteria; and generating a template based on the at least one of the identified first object of interest or the identified second object of interest, wherein the generated template is a short-term template.

According to certain embodiments, a method for multiple-object tracking is provided. The method includes: receiving a first image frame in a sequence of image frames: performing object tracking using an object tracker to identify a plurality of objects of interest based at least in part on one or more first templates associated with a first object of interest from the plurality of objects of interest, one or more second templates associated with a second object of interest from the plurality of objects of interest, and a spatial relationship between at least two objects of interest of the plurality of objects of interest, wherein the spatial relationship comprises a distance between at least two objects of interest of the plurality of objects of interest; and outputting a plurality of indicators. Each indicator of the plurality of indicators is associated with a respective image portion. Each image portion of the respective image portions corresponds to a respective object of interest of the plurality of objects of interest. The method further includes: determining whether at least one of the objects of interest satisfies one or more criteria; and generating a template based on the at least one of the objects of interest. The method is performed using one or more processors. For example, the method is implemented according to at least FIG. 1, FIGS. 2A, FIG. 2B, FIG. 3, FIG. 4, and/or FIG. 5.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for multiple-object tracking, the method comprising:
receiving a first image frame in a sequence of image frames;
performing object tracking using an object tracker to identify a first object of interest and a second object of interest in the first image frame based at least in part on one or more first templates associated with the first object of interest, one or more second templates associated with the second object of interest, and a spatial relationship between the first object of interest and the second object of interest;
outputting a first indicator associated with a first image portion corresponding to the identified first object of interest; and
outputting a second indicator associated with a second image portion corresponding to the identified second object of interest,
wherein the method is performed using one or more processors.

2. The method of claim 1, further comprising:
receiving a user input associated with the first object of interest, the user input indicating an identified image portion in a second image frame in the sequence of image frames; and
generating a retargeted template based at least in part on the identified image portion.

3. The method of claim 2, wherein the spatial relationship is a first spatial relationship, wherein the method further comprises:
determining a second spatial relationship between the first object of interest and the second object of interest based at least in part on the retargeted template.

4. The method of claim 3, further comprising:
removing the first spatial relationship from a data repository; and
storing the second spatial relationship in the data repository.

5. The method of claim 2, further comprising:
storing the retargeted template to a long-term template repository of the template repository.

6. The method of claim 1, wherein the spatial relationship includes a spatial graph.

7. The method of claim 1, further comprising:
determining an identified spatial relationship between the identified first object of interest and the identified second object of interest; and
determining a confidence score associated with the identified first object of interest and the identified second object of interest based at least in part on the identified spatial relationship and the spatial relationship stored in a data repository.

8. The method of claim 7, wherein the confidence score is at a low level if the identified spatial relationship indicates an opposite relative location from a relative location indicated by the spatial relationship.

9. The method of claim 8, wherein the opposite relative location comprises a relative location from a reference object including at least one of a left side of the reference object, a right side of the reference object, in front of the reference object, or behind the reference object.

10. The method of claim 1, further comprising:
determining whether at least one of the identified first object of interest or the identified second object of interest satisfies one or more criteria; and
generating a template based on the at least one of the identified first object of interest or the identified second object of interest,
wherein the generated template is a short-term template.

11. A system for multiple-object tracking, the system comprising:
at least one processor; and
at least one memory storing instructions that, when executed by the at least one processor, causes the system to perform a set of operations, the set of operations comprising:
receiving a first image frame in a sequence of image frames;
performing object tracking using an object tracker to identify a first object of interest and a second object of interest in the first image frame based at least in part on one or more first templates associated with the first object of interest, one or more second templates associated with the second object of interest, and a spatial relationship between the first object of interest and the second object of interest;
outputting a first indicator associated with a first image portion corresponding to the identified first object of interest; and
outputting a second indicator associated with a second image portion corresponding to the identified second object of interest,
wherein the method is performed using one or more processors.

12. The system of claim 11, wherein the set of operations further comprise:
receiving a user input associated with the first object of interest, the user input indicating an identified image portion in a second image frame in the sequence of image frames; and
generating a retargeted template based at least in part on the identified image portion.

13. The system of claim 12, wherein the spatial relationship is a first spatial relationship, and wherein the set of operations further comprises:
determining a second spatial relationship between the first object of interest and the second object of interest based at least in part on the retargeted template.

14. The system of claim 13, wherein the set of operations further comprises:
removing the first spatial relationship from a data repository; and
storing the second spatial relationship in the data repository.

15. The system of claim 12, wherein the set of operations further comprises:
storing the retargeted template to a long-term template repository of the template repository.

16. The system of claim 11, wherein the spatial relationship includes a spatial graph.

17. The system of claim 11, wherein the set of operations further comprises:
determining an identified spatial relationship between the identified first object of interest and the identified second object of interest; and
determining a confidence score associated with the identified first object of interest and the identified second object of interest based at least in part on the identified spatial relationship and the spatial relationship stored in a data repository, and
wherein the confidence score is at a low level if the identified spatial relationship indicates an opposite relative location from a relative location indicated by the spatial relationship.

18. The system of claim 17, wherein the opposite relative location comprises a relative location from a reference object including at least one of a left side of the reference object, a right side of the reference object, in front of the reference object, or behind the reference object.

19. The system of claim 11, wherein the set of operations further comprises:
determining whether at least one of the identified first object of interest or the identified second object of interest satisfies one or more criteria; and
generating a template based on the at least one of the identified first object of interest or the identified second object of interest,
wherein the generated template is a short-term template.

20. A method for multiple-object tracking, the method comprising:
receiving a first image frame in a sequence of image frames;
performing object tracking using an object tracker to identify a plurality of objects of interest based at least in part on one or more first templates associated with a first object of interest from the plurality of objects of interest, one or more second templates associated with a second object of interest from the plurality of objects of interest, and a spatial relationship between at least two objects of interest of the plurality of objects of interest, wherein the spatial relationship comprises a distance between at least two objects of interest of the plurality of objects of interest;
outputting a plurality of indicators, each indicator of the plurality of indicators being associated with a respective image portion, each image portion of the respective image portions corresponding to a respective object of interest of the plurality of objects of interest;
determining whether at least one of the objects of interest satisfies one or more criteria; and
generating a template based on the at least one of the objects of interest,
wherein the method is performed using one or more processors.
